(19) United States
(12) Patent Application Publication
(10) Pub. No.: US 2008/0085395 A1
(43) Pub. Date: Apr. 10, 2008

(54) METHOD FOR REPAIRING OR RENEWING COOLING HOLES OF A COATED COMPONENT OF A GAS TURBINE

(75) Inventors: John William Fernihough, Ennetbaden (CH); Matthias Hoebel, Windisch (CH); Maxim Konter, Klingnau (CH)

Correspondence Address: DARBY & DARBY P.C., P.O. BOX 770, Church Street Station, New York, NY, 10008-0770, US

(73) Assignee: ALSTOM Technology Ltd, Baden (CH)

(21) Appl. No.: 11/869,048

(22) Filed: Oct. 9, 2007

Related U.S. Application Data
(63) Continuation of application No. PCT/EP2006/061125, filed on Mar. 29, 2006.

(30) Foreign Application Priority Data
Apr. 7, 2005 (CH) 00636/05

(51) Int. Cl. B05D 3/06; B32B 3/10

(52) U.S. Cl. 428/131; 427/142; 427/596

(57) ABSTRACT

A method for repairing or renewing cooling holes of a coated component of a gas turbine, includes the step of removing an old coating from an outer side of the component. The cooling hole, after removing the old coating, in a longitudinal section, has an old cross section which is larger than a nominal cross section which the cooling hole has in this longitudinal section in an original new state of the finished component. The method also includes applying a new coating to the component at least in the longitudinal section of the cooling hole so that the cooling hole, in the longitudinal section, has an interim cross section which is smaller than the nominal cross section. The method also includes partially removing the new coating inside the cooling hole so that the cooling hole, in the longitudinal section, has a new cross section which is about the same size as the nominal cross section.

This application is a continuation from International Application No. PCT/EP2006/061125, filed on Mar. 29, 2006, which claims priority to Swiss Patent Application No. CH 00636/05, filed on Apr. 7, 2007. The entire disclosure of both applications is incorporated by reference herein.

The present invention relates to a method for repairing or renewing cooling holes of a coated component of a gas turbine.

### BACKGROUND

Components of gas turbines, like, for example, rotor blades, stator blades, heat shield elements or other cooled parts, frequently contain cavities which serve for distribution of cooling air to a plurality of cooling holes in a wall of the respective component. These cooling holes guide the cooling air to an outer surface which is exposed to the hot operating gases of the gas turbine. Such components are customarily provided with an anti-oxidation and/or anti-corrosion coating, which can also be referred to as a base coating. In addition, the components can also be provided with a thermal barrier coating, which serves for a thermal insulation of the component. During operation of the gas turbine, in this case there frequently occurs a degradation of the coating, or coatings, as the case may be, before the coated component itself is affected. As a consequence, the base coating and, if necessary, the thermal barrier coating, must be removed and newly applied, at least once during the service life of the respective component.

When applying a new coating, however, the existing cooling holes are problematical. While during production of a new component, the cooling holes are introduced into the component only after applying the coating, when re-applying a new coating, the cooling holes are already available. When applying the new coating, the coating material can penetrate into the cooling holes and alter their cross sections. The components of modern gas turbines in this case can contain hundreds of such cooling holes, the cross sections or cross sectional contours of which lie within very close tolerance limits. The upper tolerance limit for the cooling hole cross sections should avoid blowing in of unnecessary cooling air which would drastically reduce the efficiency of the gas turbine and also its power output. The lower tolerance limit for the cooling hole cross sections should avoid overheating of the respective component which would lead to an appreciable shortening of the service life of the respective component.

For repairing or renewing the cooling holes, it is basically possible to weld up or solder up the cooling holes after removing the old coating. After that, the new coating can be applied. The cooling holes can then be redrilled. In this case, it is problematic that the welding processes or soldering processes which are used for this purpose introduce weakened points in the material of the component. Furthermore, a customary drilling process is associated with positional tolerances so that during the new drilling of the cooling holes positional deviations to the old cooling holes can occur. This results in the welding material or soldering material remaining in the material of the component so that the component with the aforesaid weakened points is put into service which negatively affects the mechanical strength of the component.

From U.S. Pat. No. 5,702,288, it is known to apply the new coating, after removing the old coating, without previous soldering up or welding up the cooling holes. As a result of this, the new coating penetrates to a greater or lesser extent into the cooling holes and narrows their cross section. An abrasively acting grinding swarf is then introduced under high pressure into the cavity of the component and expelled through the cooling holes. In this way, the coating inside the cooling holes can be ground off. However, during this course of action internal regions of the component, like, for example, cooling fins or inserts, as well as uncoated regions of the cooling holes, are also exposed to the abrasive action of the grinding swarf. Furthermore, such a process is unsuitable for stator blades, which contain a cooling air distribution insert, since such a distribution insert would first have to be removed, which, however, would be time-intensive and cost-intensive. Furthermore, it is basically possible to press the grinding swarf through the cooling holes into the cavity of the component from the outside. With this, however, the same difficulties basically arise, wherein the coating of the component is additionally also exposed to the abrasive action of the grinding swarf.

From U.S. Pat. No. 4,743,462, it is known to introduce temporary plugs into the cooling holes before applying the new coating, which plugs at least partially evaporate during the coating process. The evaporation of the plugs in this case prevents clogging of the cooling holes by the coating material. With this, however, it is disadvantageous that the plugs have to be individually introduced into the cooling holes. In the case of large components of stationary gas turbines, which can have several hundreds of cooling holes, introducing the plugs individually into each cooling hole is extremely time-intensive. Furthermore, different components can have various types of cooling holes which require specially adapted plugs in each case.

From U.S. Pat. No. 5,985,122, U.S. Pat. No. 6,258,226 and from U.S. Pat. No. 5,565,035, it is known to plug a plurality of cooling holes at the same time, by means of a corresponding tool, before applying the new coating. These tools, however, are not suitable for thermal spray coating processes.

From U.S. Pat. No. 5,800,695, it is known to press a masking medium through the cavity into the cooling holes from the inside until the masking medium reaches the outer surface of the respective component. An electrolytic platinum coating can then be carried out. Since the masking medium consists of plastic and consequently is not electrically conducting, the platinum cannot settle on the masking medium in the region of the cooling holes.

From U.S. Pat. No. 4,743,462, a further method is known, which operates with a masking medium, wherein this already evaporates at temperatures which lie below the temperatures which occur when applying the coating. It is necessary, for example, for defined anti-oxidation and/or anti-corrosion coatings that these form a diffusion bond with the material of the component. In order to achieve such a diffusion bond, a high temperature treatment is necessary, which, for example, proceeds in a temperature range of 1000° C. to 1150° C. At these high temperatures, the masking medium evaporates in any case. In order to then be able to apply a thermal barrier coating, the masking medium would have to be reintroduced.

From U.S. Pat. No. 6,004,620, it is known to remove areas of the coating, which have penetrated into the cooling holes, by means of a high pressure water jet. However, the device, by means of which the high pressure water jet can be introduced into the individual cooling holes, is too unmanageable in order to clean the cooling holes of a turbine blade, for example, from the inside by it. Further methods, which operate with a high pressure water jet, are known from US 2001/001680 and from US 2001/006707.

Furthermore, from U.S. Pat. No. 6,210,488, it is known to remove a thermal barrier coating, which has been deposited inside the cooling holes, by means of a caustic solution, wherein an ultrasonic treatment can optionally be provided. Such a course of action, however, is only suitable for the complete removal of the thermal barrier coating from the whole component. Masking of the thermal barrier coating of the whole component, apart from the individual cooling holes, is not feasible.

From U.S. Pat. No. 5,216,808, it is known to remove the unwanted thermal barrier coating inside the cooling holes by means of a pulsed ultraviolet laser. The wave length of the UV laser is indeed suitable for removing customary thermal barrier coatings, for example consisting of zirconium oxide, however customary anti-oxidation and/or anti-corrosion coatings, cannot be consistently removed or only unreliably removed by it.

A further method, which operates with a masking medium, is known from U.S. Pat. No. 6,265,022. The masking medium which is used there is based on a polymer base and can be used for all those coating processes in which the temperatures do not exceed a temperature which brings about destruction of the masking medium. In contrast to the aforementioned masking process, in this process the masking medium is introduced so that at an outlet opening of the respective cooling hole it projects beyond the outer surface of the component.

Furthermore, from U.S. Pat. No. 6,042,879, it is known to first widen the cooling holes before applying the new coating, in such a way that the subsequent coating, due to the penetrating of the coating material into the cooling holes, reduces the cross section of the cooling holes to a greater or lesser extent to a desired nominal cross section. It is obvious that such a course of action is encumbered with extreme tolerances.

### SUMMARY OF THE INVENTION

An object of the present invention is to provide a method for repairing or renewing cooling holes of a coated component of a gas turbine that increased the service life of the repaired or renewed cooling hole.

According to the present invention, the repair or renewal of the cooling holes is performed so that the cooling holes then have basically the same cross sections or basically the same cross sectional contours as in the original unused state of the finished component. At the same time, however, a longitudinal section of the respective cooling hole, which extends to the outer side of the component, is also to be provided with the new coating. The reproduction of the original geometry of the cooling hole provides for the cooling hole being able to optimally fulfil the function for which it is intended. At the same time, the risk of hot operating gas being able to penetrate into the cooling hole is reduced as a result of this. Furthermore, the new coating, which reaches into the longitudinal section of the cooling hole, brings about an intensive protection of the material of the component against the aggressive hot operating gases, if these were to still penetrate into the respective cooling hole. In this way, corrosion of the cooling hole, and therefore a cross sectional widening, can be avoided. A cooling hole cross section which is widened as a result of corrosion during operation of the gas turbine, makes penetrating of the aggressive operating gas into the cooling hole easier, and, as a result, intensifies the corrosive action which leads to an increased further cross sectional widening.

By means of the repair method or reproduction method according to the invention, the repaired cooling holes have at least the same resistance, if not even an improved resistance, to the aggressive hot operating gases of the gas turbine.

For realization of the invention, on the one hand removing of the at least one old coating is carried out so that the drilled hole, at least in the aforesaid longitudinal section, then has an old cross section or old cross sectional contour, the opening width of which is larger than a nominal cross section or nominal cross sectional contour which the drilled hole has in the new state in the case of an unused component. The coating with the at least one new coating is then purposefully carried out so that this longitudinal section of the cooling hole has an interim cross section or interim cross sectional contour, the opening width of which is smaller than in the nominal cross section or nominal cross sectional contour. In this way, it is ensured that during the subsequent “drilling out” of the individual cooling holes the original nominal cross section or nominal cross sectional contour can again be produced. In the invention, this “drilling out” is realized by a partial removal of the new coating inside the cooling hole in such a way that the cooling hole, in the longitudinal section and especially in the hole region which penetrates the new coating, then has a new cross section or new cross sectional contour, which basically corresponds to the nominal cross section or to the nominal cross sectional contour.

The partial removal of the new coating is expediently carried out by a suitable laser method. For this purpose, especially laser abrasion methods or laser milling methods and/or laser drilling methods are suitable.

For the new coating, which extends into the longitudinal section of the cooling hole, an anti-oxidation and/or anti-corrosion coating is applied.

The present invention also provides a component of a gas turbine, which has at least one cooling hole which is also coated in a longitudinal section which is adjacent to the outer side of the component, wherein the cooling hole otherwise has a desired nominal cross section or a nominal cross sectional contour along its entire length.

Further important features and advantages of the present invention result from the dependent claims, from the drawings and from the associated figure description, with reference to the drawings.

### BRIEF DESCRIPTION OF THE DRAWINGS

Preferred exemplary embodiments of the invention are represented in the drawings and are explained in detail in the subsequent description, wherein like designations refer to like or similar, or functionally alike components.

In the drawing, schematically in each case,

FIGS. 1A to 1E show in each case a cross section through a component in the region of a cooling hole in different states (A to E),

FIGS. 2A to 2E show views as in FIGS. 1A to 1E, however in another embodiment of the cooling hole,

FIGS. 3A to 3E show views as in FIGS. 1A to 1E, however in a further embodiment of the cooling hole.

### DETAILED DESCRIPTION

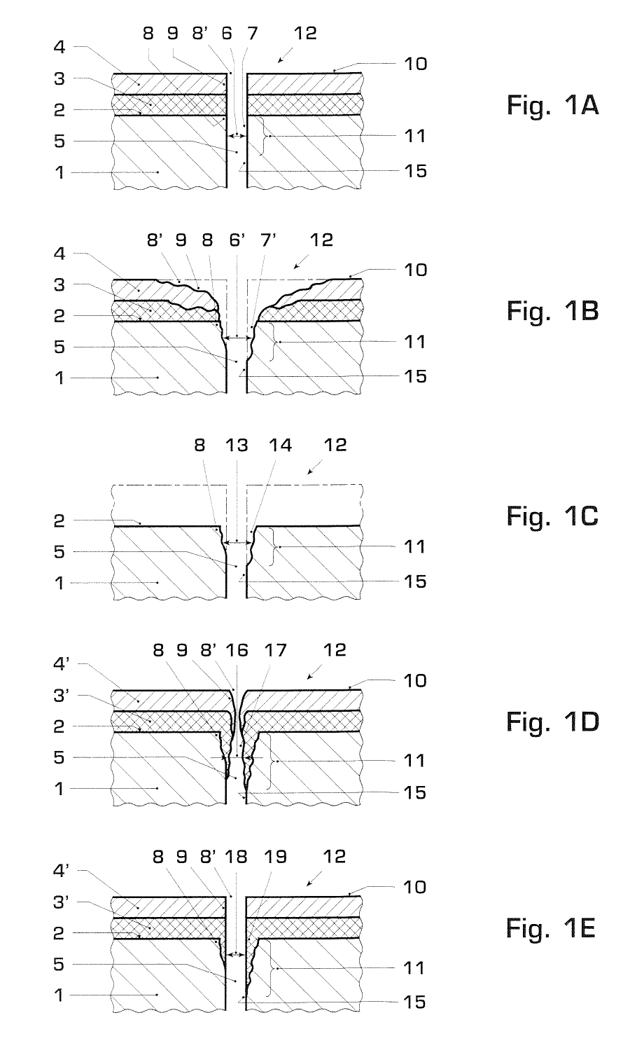

FIGS. 1A, 2A and 3A show in each case a component 1 of a gas turbine, which otherwise is not shown, which component is provided with at least one coating on its outer side 2. In the preferred embodiment which is shown here, the component 1 is provided in each case with two coatings, specifically with a first coating 3 and a second coating 4. While the first coating 3 is applied to the component 1, the second coating 4 is applied to the first coating 3. In another embodiment, the component 1 can have only one single coating, or even more than two coatings. The method according to the invention is then correspondingly applicable.

The sections of the component 1 which are shown in each case are provided with a cooling hole 5. It is clear that the component 1 can basically have more than one such cooling hole 5.

In the case of the component 1, for example, it is a rotor blade, or a stator blade, or a heat shield element, or another cooled component. Each cooling hole 5 leads from a cavity, which is not shown, inside the component 1, to the outer side 2. Furthermore, the respective cooling hole 5 extends through the coatings 3, 4 to an outer skin 10 of the coated component 1.

In the case of the first coating 3, it is expediently an anti-oxidation and/or anti-corrosion coating. Such an anti-oxidation and/or anti-corrosion coating for example can be formed by a metal coating, especially consisting of MCrAlY. In this case, M is at least one member of the following group: iron (Fe), copper (Cu), nickel (Ni) and cobalt (Co), and also combinations thereof. In this connection, NiCrAlY, CoCrAlY, NiCoCrAlY are especially to be emphasized. In the case of the second coating 4, in contrast to this, it is preferably a thermal barrier coating. Such a thermal barrier coating, for example, can be achieved by a ceramic coating which, for example, consists of zirconium oxide. The anti-oxidation and/or anti-corrosion coating, that is the first coating 3, for example can have a layer thickness of 150 μm to 600 μm. In contrast to this, the thermal barrier coating, that is the second coating 4, can preferably have a layer thickness of about 200 μm to 500 μm.

In FIGS. 1A, 2A and 3A, the component 1 is in an original new state which it has after its coating with the coatings 3 and 4 and after the introducing of the cooling holes 5. In this new state, each cooling hole 5 has a desired nominal cross section or a desired nominal cross sectional contour in the longitudinal direction of the cooling hole 5. In FIGS. 1A, 2A and 3A, the nominal cross section in this case is designated by 6, while the nominal cross sectional contour is designated by 7.

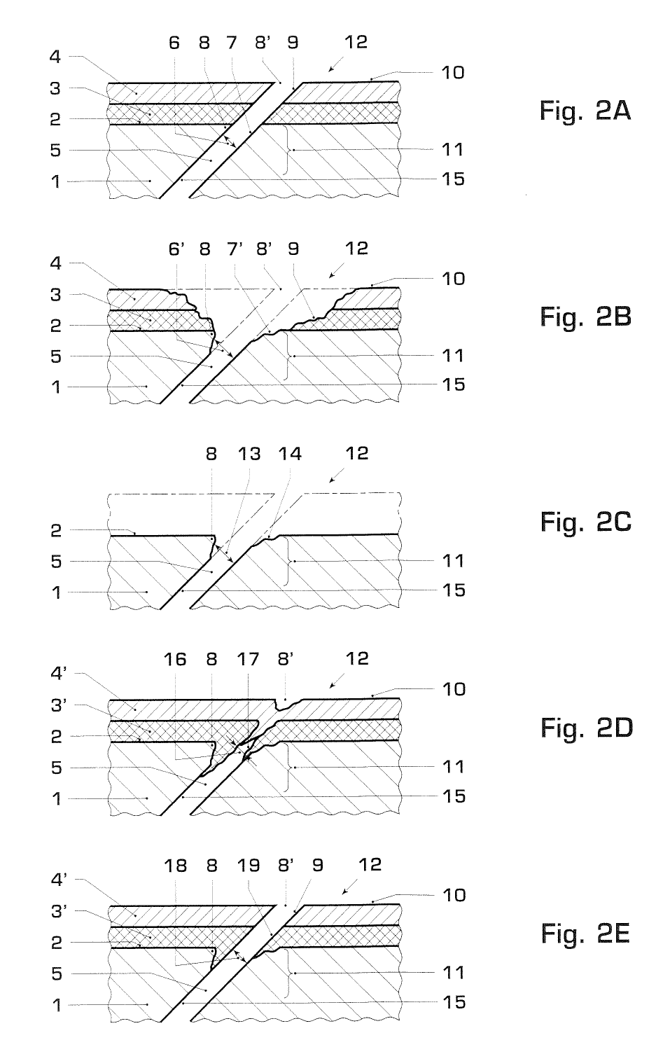

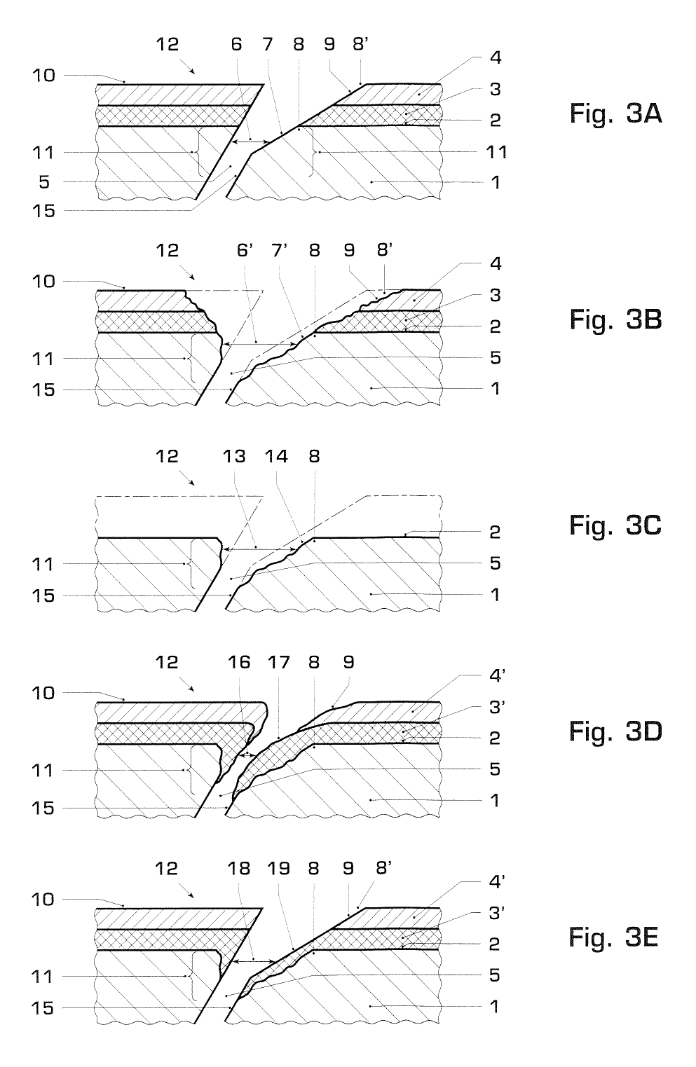

The embodiments of FIGS. 1, 2 and 3 differ by the design of the cooling holes 5. In the new state, the cooling hole 5 in the embodiments of FIGS. 1A and 2A has a constant nominal cross section 6 in its longitudinal direction. The nominal cross section 6 for example can be circular. In contrast to this, in the embodiment according to FIG. 3A, the cooling hole 5 is provided with a nominal cross sectional contour 7 which is widened towards an outlet opening 8 of the cooling hole 5. The outlet opening 8 is located at the outflow side end of the cooling hole 5 which extends inside the component 1, and, therefore, is located at the level of the outer side 2 of the component 1. In the coated component 1, however, the cooling hole 5 is extended through the coatings 3, 4, as a result of which the outlet opening is also displaced towards the outer skin 10 of the coated component 1, that is towards the outer side of the second coating 4. This outer outlet opening is subsequently designated by 8′.

As a result, for example an aerodynamically designed outlet section 9 can be achieved inside the component 1 or inside the coatings 3, 4. An aerodynamically designed outlet section 9, for example, improves the formation of a cooling film which is applied to the outer skin 10 of the coated component 1 during operation of the gas turbine and consequently improves the cooling action or the thermal insulation of the coated component 1. Other aerodynamically designed outlet sections 9, for example, are known from U.S. Pat. No. 6,183,199, from U.S. Pat. No. 4,197,443 and from EP 0 228 338, the content of which is integrated herewith into the disclosure of the present invention by explicit reference.

The embodiments of FIGS. 2A and 3A, moreover, differ from those of FIG. 1A by the longitudinal direction of the cooling holes 5 in the embodiments of FIGS. 2A and 3A being inclined in relation to a normal direction of the outer side 2, while in the embodiment according to FIG. 1A they extend parallel to the normal direction. In the embodiment of FIG. 2A, the longitudinal direction of the cooling hole 5, for example has an angle of incidence of about 45°, while the angle of incidence in the embodiment according to FIG. 3A is only about 30°, which, however, increases to about 60° by means of the widening outlet section 9.

The nominal cross section 6 or the nominal cross sectional contour 7 which is provided for the new state of the component 1 is designed with regard to an optimum cooling action with simultaneously optimized output and optimized efficiency of the gas turbine. The nominal cross section 6 or the nominal cross sectional contour 7 in this case is produced within relatively close tolerance limits.

During operation of the gas turbine, wear of the coatings 3, 4 occurs, in fact especially in the region of the cooling holes 5. FIGS. 1B, 2B and 3B show in each case a state at a point in time at which a repair or a renewal of the cooling holes 5 is advisable. This point in time, for example, is approximately in the middle of the service life which is provided for the gas turbine or for its component 1. It can be clearly gathered from FIGS. 1B, 2B and 3B that not only the outer second protective coating 4, but also the inner first protective coating 3, and also a hole wall 15 which laterally encloses the cooling hole 5, is worn at least in one longitudinal section 11 of the cooling hole 5. This longitudinal section 11 is adjacent to the outer side 2 of the component 1 and is characterized in the figures in each case by a brace.

By means of the material wear in the coatings 3, 4 and also inside the component 1 in the longitudinal section 11, the cooling hole 5 maintains an enlarged cross section 6′ or a widened cross sectional contour 7′, at least in the longitudinal section 11 and also inside the coatings 3,4. The original contour of the cooling hole 5 and of the coatings 3, 4, that is the nominal cross section 6 or the nominal cross sectional contour 7, is indicated in FIGS. 1B, 2B and 3B in each case by a broken line.

In order to repair or to renew the cooling holes 5 which are shown in FIGS. 1B, 2B and 3B, the method according to the invention is implemented, which is explained in detail in the following:

In a first method step, the old coatings 3, 4 are removed from the outer side 2 of the component 1, in fact at least in a hole region 12 which encloses the cooling hole 5. This hole region 12 extends in the figures in each case over the entire represented detail of the component 1. In FIGS. 1C, 2C and 3C, the original contour of the cooling hole 5, and also of the coatings 3, 4, is indicated by a broken line.

Removing the old coatings 3, 4 can be carried out in a conventional manner, for example by means of an acid or by means of a caustic solution. After removing the old coatings 3, 4, the cooling hole 5 in the longitudinal section 11 has an old cross section 13 or an old cross sectional contour 14. This old cross section 13 or old cross sectional contour 14 can coincide with the widened cross section 6′ or cross sectional contour 7′ of the used state which is shown in FIGS. 1B, 2B and 3B. It is basically possible, however, that the process for removing the old coatings 3, 4 leads to a widening of the cross section or of the cross sectional contour, which, for example, is the case when corrosion deposits or oxidation deposits on the hole wall 15, which laterally defines the cooling hole 5, are also removed at the same time along with the removing of the old coatings 3, 4. In the last-named case, the old cross section 13 or the old cross sectional contour 14 is then influenced by the process of removing the old coatings 3, 4. In any case, the old cross section 13 is larger than the nominal cross section 6. The old cross sectional contour 14 is also wider than the nominal cross sectional contour 7.

In a second step of the method according to the invention, at least one new coating is applied to the component 1. In the present example, two coatings are again applied, specifically a new first coating 3′, which is applied directly to the component 1, and also a new second coating 4′, which is applied to the new first coating 3′. The new first coating 3′ in this case expediently corresponds to the original (old) first coating 3. In a corresponding way, the new second coating 4′ expediently corresponds to the original (old) second coating 4. In this case, it is clear that the new coatings 3′ and 4′ take into account a technological development which has possibly happened in coating technology, which has taken place since the point in time of the original new state according to FIGS. 1A, 2A and 3A and since the point in time of the repair.

Applying the new coatings 3′, 4′, for example, can be carried out by a high temperature spraying method, like, for example, plasma spraying. For applying the new coatings 3′, 4′, it can also be expedient between applying the new first coating 3′ and applying the new second coating 4′ to carry out a high temperature treatment, for example in order to create a diffusion bond between the materials of the new first coating 3′ and the component 1.

According to FIGS. 1D, 2D and 3D, the first new coating 3′ in this case is applied so that it extends into the cooling hole 5, in fact at least in the longitudinal section 11. Furthermore, this coating process in this case is carried out so that in the longitudinal section 11, and also inside the new coatings 3′, 4′, and also in the hole region 12, an interim cross section 16 or an interim cross sectional contour 17 is produced, which is smaller than the original nominal cross section 6 or nominal cross sectional contour 7. The new second coating 4′ in this case can also extend into the cooling hole 5 and is additionally built upon the new first coating 3′, as a result of which the interim cross section 16 or the interim cross sectional contour 17 is additionally narrowed.

As is shown in FIG. 2D, when applying the new coatings 3′, 4′ the interim cross section 16 can also shrink to the zero value at many points, that is to say the new coating 3′, 4′ completely closes off the cooling hole 5.

After producing the new coatings 3′, 4′, partial removing of the new coatings 3′, 4′, in fact from the hole wall 15, now follows in accordance with the method according to the invention in a third step. This partial removing of the new coatings 3′, 4′ in this case is carried out so that the cooling hole 5, corresponding to FIGS. 1E, 2E and 3E, at least in the longitudinal section 11 and also in the hole region 12, that is inside the new coatings 3′, 4′, then has a new cross section 18 or new cross sectional contour 19. The partial removal of the new coatings 3′, 4′ in this case is purposefully carried out so that the new cross section 18 or the new cross sectional contour 19 is the about same size as the nominal cross section 6 or the nominal cross sectional contour 7. Since the old cross section 13 or the old cross sectional contour 14 has a greater opening width than the nominal cross section 6 or the nominal cross sectional contour 7, the component 1, in the longitudinal section 11 of the cooling hole 5, is provided with the material of the new first coating 3′. Along the longitudinal section 11, the hole wall 15 is correspondingly formed by the region of the new first coating 3′ which projects into the cooling hole 5.

Since the cooling hole 5 after its repair or after its renewal basically has the same dimension and shape as in the new state, the cooling capacity which was originally provided can consequently again be achieved during operation of the gas turbine. At the same time, a high efficiency and also a high power output of the gas turbine, as in the new state, are again achieved. In this case, it is especially advantageous that the hole wall 15, at least in the region of the longitudinal section 11, is coated with the material of the new first coating 3′, as a result of which the hole wall 15 is protected against corrosion which can occur in the cooling hole 5 during entry of the aggressive hot operating gases. The durability of the repaired cooling hole 5, therefore, is at least equal to or even greater than the service life of the original cooling hole 5 in the new state of the component 1.

FIGS. 1E, 2E, 3E therefore show a component 1 with a repaired cooling hole 5, which differs from the original component 1 in the new state by the new first coating 3′ extending into the longitudinal section 11.

In order to be able to partially remove the new coatings 3′, 4′ in the region of the cooling hole 5, a laser method is preferably used. In this connection, for example a laser milling method and/or a laser drilling method is a possibility. Such a milling method and/or drilling method by means of a laser, for example is characterized by laser pulse energies which lie within a range of 1 J to 60 J. In this case, pulse times occur within the range of 0.1 ms to 20 ms.

Alternatively, a laser abrasion method can also be used, which is especially characterized by pulse times which lie within the range of about 10 ns to 1000 ns. This corresponds to pulse frequencies within the range of about 1 kHz to 100 kHz. In the case of the laser abrasion method, the energy density in the single pulse is appreciably greater than in the case of laser milling or laser drilling. At the same time, less material volume is influenced on account of the appreciably smaller pulse energy (1 mJ to 50 mJ). As a result of this, a re-solidifying of the molten regions of the new coatings 3′, 4′ which are to be removed can especially be avoided. The laser abrasion method correspondingly leads to an extremely clean new cross sectional contour 19.

The method according to the invention can naturally also be implemented in the case of a component 1 which has a plurality of cooling holes 5, wherein it is then especially possible to implement the method on a plurality of cooling holes 5 at the same time or to implement the method in a relatively staggered manner with regard to the individual method steps.

What is claimed is:

1. A method for repairing or renewing a cooling hole of a coated component of a gas turbine, the method comprising:
removing at least one old coating from an outer side of the component in a hole region of the component, the hole region containing the cooling hole, wherein, after the removing of the at least one old coating, a cross-section of the cooling hole at a longitudinal section of the cooling hole adjacent to the outer side has an old cross section that is larger than a corresponding nominal cross section of the cooling hole at the longitudinal section in an original new state of the component;
applying at least one new coating to the component in the hole region and in the longitudinal section of the cooling hole so that an interim cross section of the cooling hole at the longitudinal section that is smaller than the nominal cross section; and
partial removing a portion of the at least one new coating inside the cooling hole so that the cooling hole has a new cross section at the longitudinal section that is substantially the same size as the nominal cross section.

2. The method as recited in claim 1, wherein the partial removing of the portion of the at least one new coating is performed using a laser method.

3. The method as recited in claim 2, wherein the laser method includes at least one of a laser milling method and a laser drilling method.

4. The method as recited in claim 2, wherein the laser method is performed using laser pulse energies within the range of 1 J to 60 J.

5. The method as recited in claim 2, wherein the laser method is performed using laser pulse times within the range of 0.1 ms to 20 ms.

6. The method as recited in claim 2, wherein the laser method is performed using laser pulse frequencies within the range of 1 Hz to 50 Hz.

7. The method as recited in claim 2, wherein the laser method is a laser abrasion method.

8. The method as recited in claim 7, wherein the laser abrasion method operates with laser pulse energies within the range of 1 mJ to 50 mJ, and/or with pulse times within the range of 10 ns to 1000 ns, and/or with pulse frequencies within the range of 1 kHz to 100 kHz.

9. The method as recited in claim 1, wherein the removing of the at least one old coating includes removing an old anti-oxidation and/or anti-corrosion coating applied to the outer side of the component, and an old thermal barrier coating applied to the anti-oxidation and/or anti-corrosion coating.

10. The method as recited in claim 1, wherein the applying the at least one new coating includes applying a new anti-oxidation and/or anti-corrosion coating in the hole region and in the longitudinal section and applying a new thermal barrier coating to the anti-oxidation and/or anti-corrosion coating at least in the hole region.

11. The method as recited in claim 10, wherein the new anti-oxidation and/or anti-corrosion coating includes a metal coating.

12. The method as recited in claim 10, wherein the new anti-oxidation and/or anti-corrosion coating includes a MCrAlY coating, wherein M includes at least one member of the following group: iron, copper, nickel, cobalt.

13. The method as recited in claim 10, wherein the new anti-oxidation and/or anti-corrosion coating includes a ceramic coating.

14. The method as recited in claim 10, wherein the new thermal barrier coating includes a zirconium oxide.

15. The method as recited in claim 10, wherein the new anti-oxidation and/or anti-corrosion coating is applied with a layer thickness of about 150 μm to 600 μm.

16. The method as recited in claim 10, wherein the new thermal barrier coating is applied with a layer thickness of about 200 μm to 500 μm.

17. The method as recited in claim 1, wherein the cooling hole has at least one of: a constant nominal cross section along its length, an inclined longitudinal direction towards the outer side relative to a normal, an aerodynamic outlet section with varying nominal cross section, and a widening nominal cross section towards an outlet opening of the cooling hole.

18. The method as recited in claim 1, wherein the longitudinal section of the cooling hole, after the removing of the at least one coating, has an old cross sectional contour having individual cross sections that are larger than the associated nominal cross sections of a nominal cross section contour of the longitudinal section.

19. The method as recited in claim 1, wherein the longitudinal section of the cooling hole, after applying the at least one new coating, has an interim cross sectional contour having individual interim cross sections that are smaller than the associated nominal cross sections of a nominal cross sectional contour of the longitudinal section.

20. The method as recited in claim 1, wherein the longitudinal section of the cooling hole, after the partial removing of the at least one new coating, has a new cross sectional contour having individual new cross sections that are substantially the same size as the associated nominal cross sections of a nominal cross sectional contour of the longitudinal section.

21. The method as recited in claim 1, wherein the component includes a plurality of further cooling holes, and wherein the method comprises performing the steps of the method, simultaneously or in a time-staggered manner, on each of the plurality of further cooling holes.

22. A coated component of a gas turbine, comprising:
an outer side;
at least one cooling hole having a longitudinal section adjacent to the outer side that encloses the cooling hole, wherein a cross section of the longitudinal section is approximately the same as a nominal cross section of the longitudinal section in an original new state of the component; and
at least one coating disposed on the outer side and extending at least into the longitudinal section.
